(19) United States
(12) Patent Application Publication
(10) Pub. No.: US 2026/0161033 A1
(43) Pub. Date: Jun. 11, 2026

(54) ARRAY SUBSTRATE, DISPLAY PANEL, AND DISPLAY DEVICE

(71) Applicants: Chengdu BOE Display Sci-Tech Co., Ltd., Chengdu, Sichuan (CN); BOE Technology Group Co., Ltd., Beijing (CN)

(72) Inventors: Lu BAI, Beijing (CN); Yanmei LUO, Beijing (CN)

(21) Appl. No.: 18/708,276

(22) PCT Filed: Aug. 2, 2023
(86) PCT No.: PCT/CN2023/110744

§ 371 Date: May 8, 2024

(51) Int. Cl. G02F 1/1362

(52) U.S. Cl. CPC G02F 1/136286; G02F 1/136227; G02F 2201/123

(57) ABSTRACT

Disclosed are an array substrate, a display panel, and a display device. The array substrate includes: a base substrate; gate line groups; data lines; transistors; first pixel electrodes and second pixel electrodes; where an orthographic projection, on the base substrate, of at least one of a plurality of common wires is between orthographic projections, on the base substrate, of adjacent gate line groups; and an orthographic projection, on the base substrate, of at least one of a plurality of connection lines is in an orthographic projection, on the base substrate, of a gap between adjacent pixel electrode rows; and an insulation layer and the common wires having first via holes, where orthographic projections, on the base substrate, of the first via holes are in orthographic projections, on the base substrate, of regions between two pixel edge extension lines, extending in a second direction, of pixel electrodes.

### CROSS-REFERENCE TO RELATED APPLICATIONS

The application is a National Stage of International Application No. PCT/CN2023/110744, filed Aug. 2, 2023.

### TECHNICAL FIELD

The disclosure relates to the technical field of semiconductors, and in particular to an array substrate, a display panel, and a display device.

### BACKGROUND

A thin film transistor-liquid crystal display (TFT-LCD) has a variety of common display modes, such as a twisted nematic (TN) display mode, a vertically alignment (VA) display mode, a fringe field switching (FFS) display mode, and an in-plane switching (IPS) display mode. The VA display mode is superior to the other display modes in terms of dark-state performance and contrast.

### SUMMARY

An array substrate, a display panel, and a display device are provided in embodiments of the disclosure. The array substrate includes:
a base substrate;
a plurality of gate line groups, where the plurality of gate line groups are arranged on a side of the base substrate and extend in a first direction, and at least one of the plurality of gate line groups includes: two gate lines extending in the first direction;
a plurality of data lines, where the plurality of data lines extend in a second direction;
a plurality of transistors;
a plurality of pixel electrodes, where the plurality of pixel electrodes include: a plurality of pixel electrode rows extending in the first direction and arranged in the second direction; and at least one of the plurality of pixel electrode rows includes: first pixel electrodes and second pixel electrodes that are located in regions formed by crossing the gate line groups and the data lines and are connected with the data lines through the plurality of transistors, and the second pixel electrodes are located on one sides of the first pixel electrodes far away from the data lines connected;
a plurality of common wires, where the plurality of common wires are arranged on a same side of the base substrate as the gate line groups, and an orthographic projection, on the base substrate, of at least one of the plurality of common wires is located between orthographic projections, on the base substrate, of adjacent gate line groups;
a plurality of connection lines, where the plurality of connection lines are arranged on the same side of the base substrate as the gate line groups, and an orthographic projection, on the base substrate, of at least one of the plurality of connection lines is located in an orthographic projection, on the base substrate, of a gap between adjacent pixel electrode rows; and
an insulation layer, where the insulation layer is arranged between the connection lines and the common wires and provided with a plurality of first via holes, and the common wires are connected with the connection lines at the first via holes to electrically connect at least part of the common wires through the connection lines; and orthographic projections, on the base substrate, of the first via holes are located in orthographic projections, on the base substrate, of regions between two pixel edge extension lines, extending in the second direction, of the pixel electrodes.

In some embodiments, the pixel electrodes have first symmetry axes extending in the second direction and penetrating central regions of the pixel electrodes; and the first symmetry axes penetrate central regions of the first via holes.

In some embodiments, the orthographic projections, on the base substrate, of the first via holes are located in the orthographic projections, on the base substrate, of gaps between adjacent pixel electrode rows.

In some embodiments, the first via holes include: first via sub-holes and second via sub-holes; each of the connection lines includes: first connection sub-lines and second connection sub-lines that extend in the first direction;
the first connection sub-line is electrically connected with common wires on a side of the gate line group through the first via sub-hole; and
the second connection sub-line is electrically connected with the common wire on the other side of the gate line group through the second via sub-hole.

In some embodiments, the first connection sub-line is provided with a first protrusion protruding towards one side of the pixel electrode, and the common wire is provided with a second protrusion protruding towards one side of the gate line group; an orthographic projection, on the base substrate, of the first protrusion has a first overlapping region with an orthographic projection, on the base substrate, of the second protrusion; and the first protrusion is connected with the second protrusion through the first via sub-hole in the first overlapping region;

the second connection sub-line is provided with a third protrusion protruding towards one side of the pixel electrode, and the common wire is provided with a fourth protrusion protruding towards one side of the gate line group; and an orthographic projection, on the base substrate, of the third protrusion has a second overlapping region with an orthographic projection, on the base substrate, of the fourth protrusion; and the third protrusion is connected with the fourth protrusion through the second via sub-hole in the second overlapping region.

In some embodiments, the pixel electrode is provided with a first recess at a position opposite the first protrusion; and a gap is provided between an orthographic projection, on the base substrate, of the first recess and the orthographic projection, on the base substrate, of the first protrusion; the gate line is provided with a second recess at a position opposite the second protrusion, and a gap is provided between an orthographic projection, on the base substrate, of the second recess and the orthographic projection, on the base substrate, of the second protrusion;

the pixel electrode is provided with a third recess at a position opposite the third protrusion, and a gap is provided between an orthographic projection, on the base substrate, of the third recess and the orthographic projection, on the base substrate, of the third protrusion; and the gate line is provided with a fourth recess at a position opposite the fourth protrusion, and a gap is provided between a orthographic projection, on the base substrate, of the fourth recess and the orthographic projection, on the base substrate, of the fourth protrusion.

In some embodiments, the connection line include: a plurality of connection rings sequentially distributed in the first direction, and serial connection portions connecting adjacent connection rings; and the connection ring includes the first connection sub-line and the second connection sub-line.

In some embodiments, the first via sub-hole and the second via sub-hole are respectively located in different connection rings.

In some embodiments, the first via sub-hole and the second via sub-hole are located in a same connection ring.

In some embodiments, the first pixel electrode is provided with a first outer edge on a side far away from the second pixel electrode and extending in the second direction, and the second pixel electrode is provided with a second outer edge on a side far away from the first pixel electrode and extending in the second direction; and

an orthographic projection, on the base substrate, of the connection ring is located in an orthographic projection, on the base substrate, of a region between an extension line of the first outer edge and an extension line of the second outer edge.

In some embodiments, a length of the connection ring in the first direction is 1 time to 2 times a length of the pixel electrode in the first direction;

a minimum line width of the first connection sub-line is smaller than a maximum width of the gate line in the second direction; a minimum line width of the second connection sub-line is smaller than the maximum width of the gate line in the second direction; and a line width of the serial connection portion is smaller than the maximum width of the gate line in the second direction.

In some embodiments, an orthographic projection, on the base substrate, of an outer edge of the connection ring in the first direction partially overlaps with an orthographic projection, on the base substrate, of an outer edge of the gate line towards the pixel electrode.

In some embodiments, the connection lines and the pixel electrodes are located in a same layer and made of a same material.

In some embodiments, at least one of the plurality of transistors includes: a gate electrode electrically connected with the gate line, a first electrode electrically connected with the data line, and a second electrode electrically connected with the pixel electrode; and

a second electrode, connected with the first pixel electrode, of one transistor and a second electrode, connected with the second pixel electrode, of another transistor are symmetrical with respect to the data line.

In some embodiments, the second electrode includes: a first portion and a second portion extending in the second direction, where an extension line of the first portion and an extension line of the second portion do not overlap with each other; and

a third portion that extends in the first direction and connects the first portion and the second portion;

where a length of a third portion, connected with the first pixel electrode, of the one transistor is substantially equal to a length of a third portion, connected with the second pixel electrode, of the another transistor.

In some embodiments, an orthographic projection, on the base substrate, of the extension line of a first portion of the one transistor connected with the first pixel electrode is located in an orthographic projection, on the base substrate, of a gap between adjacent pixel electrodes.

In some embodiments, an orthographic projection, on the base substrate, of the second portion has an overlapping region with an orthographic projection, on the base substrate, of the pixel electrode.

In some embodiments, the second electrode includes: a fourth portion extending in the second direction, and a fifth portion extending in the first direction and connected with one end of the fourth portion; and

an orthographic projection, on the base substrate, of the fourth portion has an overlapping region with an orthographic projection, on the base substrate, of a gap between adjacent pixel electrodes.

In some embodiments, the array substrate includes: first common signal lines between adjacent gate line groups and extending in the first direction, and first common signal extension lines connected with one sides of the first common signal lines and extending in the second direction; and at least some of the first common signal extension lines serve as the common wires.

In some embodiments, the array substrate includes: second common signal line groups between adjacent gate line groups and extending in the second direction, where each of the second common signal line groups includes two second common signal lines located on different sides of the data line respectively; each of the second common signal lines includes: a primary portion of second common signal line extending in the second direction, and a branch portion of second common signal line extending from one end of the primary portion of second common signal line in the first direction; and at least some of the second common signal lines serve as the common wires, and the second common signal line is electrically connected with the connection line through the branch portion of second common signal line.

In some embodiments, the array substrate includes: a third common signal line between adjacent gate line groups and extending in the second direction, and an orthographic projection of the third common signal line on the base substrate, is located between an orthographic projection of the first pixel electrode on the base substrate and an orthographic projection of the second pixel electrode on the base substrate.

In some embodiments, the common wires and the gate lines are located in a same layer and made of a same material.

Based on the same inventive concept, a display panel is further provided in embodiments of the disclosure. The display panel includes the array substrate according to embodiments of the disclosure and further includes an opposite substrate arranged opposite to the array substrate, where a common electrode layer is arranged on a side of the opposite substrate facing the array substrate.

Based on the same inventive concept, a display device is further provided in embodiments of the disclosure. The display device includes the display panel according to embodiments of the disclosure.

### BRIEF DESCRIPTION OF FIGURES

FIG. 1 is a first schematic diagram of a principle of generating shake head stripes.

FIG. 2 is a second schematic diagram of a principle of generating shake head stripes.

FIG. 3 is a schematic diagram of shake head stripes.

FIG. 4A is a first schematic diagram of an array substrate provided by embodiments of the disclosure.

FIG. 4B is a schematic diagram of a single film layer where a gate in FIG. 4A is located.

FIG. 4C is a schematic diagram of a single film layer where an active layer in FIG. 4A is located.

FIG. 4D is a schematic diagram of a single film layer where a data line in FIG. 4A is located.

FIG. 4E is a schematic diagram of a first via hole in FIG. 4A.

FIG. 4F is a schematic diagram of a single film layer where a pixel electrode in FIG. 4A is located.

FIG. 5A is a second schematic diagram of an array substrate provided by embodiments of the disclosure.

FIG. 5B is a schematic diagram of a single film layer where gate lines in FIG. 5A are located.

FIG. 5C is a schematic diagram of a single film layer where an active layer in FIG. 5A is located.

FIG. 5D is a schematic diagram of a single film layer where data lines in FIG. 5A are located.

FIG. 5E is a schematic diagram of a first via hole in FIG. 5A.

FIG. 5F is a schematic diagram of a single film layer where pixel electrodes in FIG. 5A are located.

FIG. 6A is a third schematic diagram of an array substrate provided by embodiments of the disclosure.

FIG. 6B is a schematic diagram of a single film layer where gate lines in FIG. 6A are located.

FIG. 6C is a schematic diagram of a single film layer where an active layer in FIG. 6A is located.

FIG. 6D is a schematic diagram of a single film layer where data lines in FIG. 6A are located.

FIG. 6E is a schematic diagram of a first via hole in FIG. 6A.

FIG. 6F is a schematic diagram of a single film layer where pixel electrodes in FIG. 6A are located.

FIG. 7A is a fourth schematic diagram of an array substrate provided by embodiments of the disclosure.

FIG. 7B is a schematic diagram of a single film layer where gate lines in FIG. 7A are located.

FIG. 7C is a schematic diagram of a single film layer where an active layer in FIG. 7A is located.

FIG. 7D is a schematic diagram of a single film layer where data lines in FIG. 7A are located.

FIG. 7E is a schematic diagram of a first via hole in FIG. 7A.

FIG. 7F is a schematic diagram of a single film layer where pixel electrodes in FIG. 7A are located.

FIG. 8A is a schematic sectional view along dotted line AA′ in FIG. 7A.

FIG. 8B is a schematic sectional view along dotted line BB′ in FIG. 7A.

FIG. 8C is a schematic sectional view along dotted line CC′ in FIG. 7A.

FIG. 8D is a schematic sectional view along dotted line DD′ in FIG. 7A.

FIG. 9A is a fifth schematic diagram of an array substrate provided by embodiments of the disclosure.

FIG. 9B is a schematic diagram of a single film layer where gate lines in FIG. 7A are located.

FIG. 10 is an equivalent schematic diagram of a pixel circuit provided by embodiments of the disclosure.

FIG. 11 is a schematic diagram of liquid crystal alignment in different regions provided by embodiments of the disclosure.

### DETAILED DESCRIPTION

In order to make the objectives, technical solutions, and advantages in embodiments of the disclosure clearer, the technical solutions in embodiments of the disclosure will be clearly and completely described below in combination with the accompanying drawings in embodiments of the disclosure. Apparently, embodiments described are merely some embodiments rather than all embodiments of the disclosure. Based on embodiments of the disclosure described, all other embodiments derived by those of ordinary skill in the art without creative efforts fall within the scope of protection of the disclosure.

The technical or scientific terms used in the disclosure have the ordinary meanings as understood by those of ordinary skill in the art to which the disclosure belongs unless defined otherwise. The words “first”, “second”, etc. used in the disclosure do not denote any order, quantity, or importance, but are merely used for distinguishing between different constituent parts. The words “comprise”, or “include” etc. mean that elements or items before the word encompass elements or items listed after the word and their equivalents, and do not exclude other elements or items. The words “connection”, “connecting”, etc. are not limited to physical or mechanical connection, but can include electrical connection whether direct or indirect. The words “upper”, “lower”, “left”, “right”, etc. are merely used to represent a relative position relation. After an absolute position of an object described is changed, the relative position relation may also be changed accordingly.

The word “about” or “substantially the same” as used herein includes a value stated and means being within an acceptable deviation range relative to a specific value as determined by those of ordinary skill in the art in view of the measurement discussed and errors (i.e. limitations of a measurement system) associated with the measurement of a specific quantity. For example, “substantially the same” can mean that a difference from the value stated is within one or more standard deviation ranges or within ranges of ±30%, 20%, 10%, or 5%.

In the accompanying drawings, the thicknesses of layers, films, panels, regions, etc. are enlarged for the sake of clarity. The illustrative implementations are described herein with reference to sectional views that serve as schematic diagrams of the idealized implementations. In this way, deviations from shapes of the figures will be expected as a result of, for example, manufacturing techniques and/or tolerances. Therefore, the implementations described herein should not be interpreted as being limited to the specific shapes of regions shown herein, but rather include deviations in shapes resulting from, for example, manufacturing. For example, regions illustrated or described as flat regions can typically have rough and/or nonlinear features. In addition, the sharp corners illustrated can be rounded. Therefore, the regions shown in the figures are illustrative in nature, and their shapes are neither intended to illustrate the precise shapes of the regions shown, nor intended to limit the scope of the claims.

In order to keep the following description of the embodiments of the disclosure clear and concise, the detailed descriptions of known functions and known components are omitted from the disclosure.

The dual gate lines design brings great challenges to the design and process of a panel. The challenges primarily include: 1. with the number of dates decreased and the number of gate lines increased, it is more difficult to charge the panel; 2. an area and a storage capacitor (Ccs) of pixels become smaller, while a parasitic capacitor of the pixels is almost unchanged, so that shake head stripes are likely to be generated under the impact of the parasitic capacitor, (for example, a coupling capacitor Cgs, (a capacitor between the gate line and the pixel that can be understood as an overall structure formed by a pixel electrode and other structures electrically connected with the pixel electrode)). For a vertically alignment (VA) product, its storage capacitor is further reduced compared with a product made through an advanced super dimension switch (ADS). In consequence, a VA dual gate line product is more susceptible to the parasitic capacitor, resulting in various defects such as the shake head stripes.

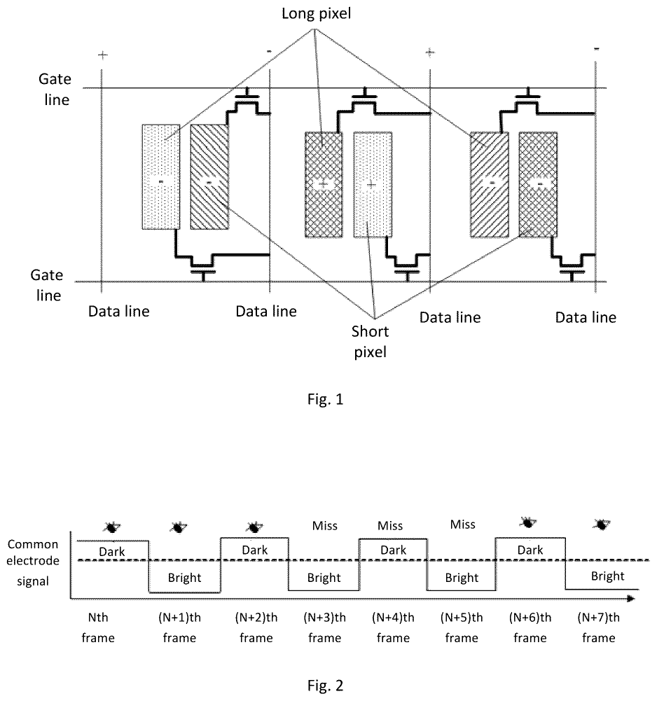

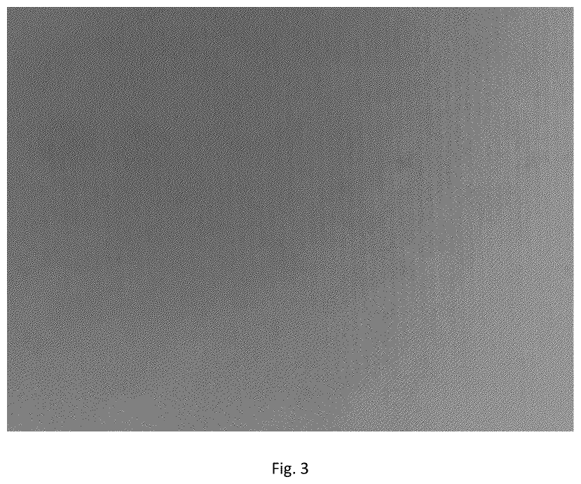

In the double gate lines design, as shown in FIG. 1, a signal loaded on a long pixel (a first long pixel in a left-to-right direction in FIG. 1) and a signal loaded on a data line (a leftmost data line) adjacent to the long pixel have the opposite polarities. When a data line signal coupled with a common electrode (COM) signal fluctuates, the long pixel becomes brighter. A signal loaded on a short pixel (a first short pixel in the left-to-right direction in FIG. 1) and a signal loaded on a data line (a second data line in the left-to-right direction) adjacent to the short pixel have the same polarity. When a data line signal coupled with a common electrode (COM) signal fluctuates, the short pixel becomes darker. If half of colors in a space indicate the same polarity, the effect can only be averaged over time. With time elapsing, when a head moves, several screens may be lost, further causing the spatial average effect to deteriorate, as shown in FIG. 2. When the head shakes left and right, vertical scrolling stripes can be seen on the screen, known as head shaking stripes, as shown in FIG. 3.

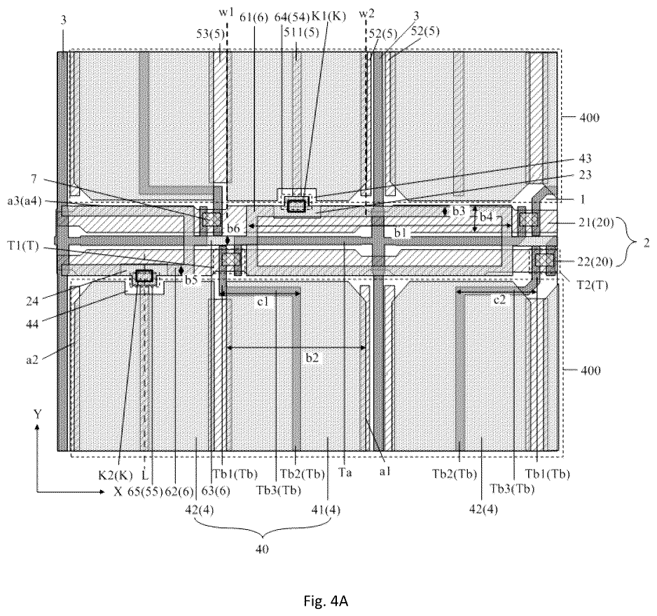

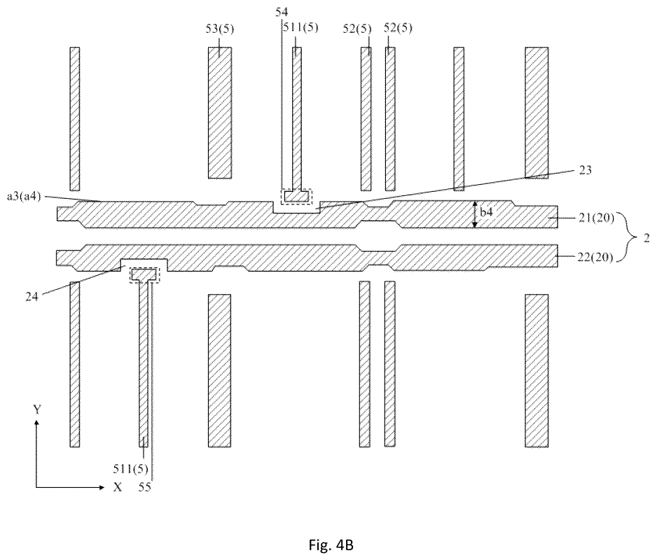

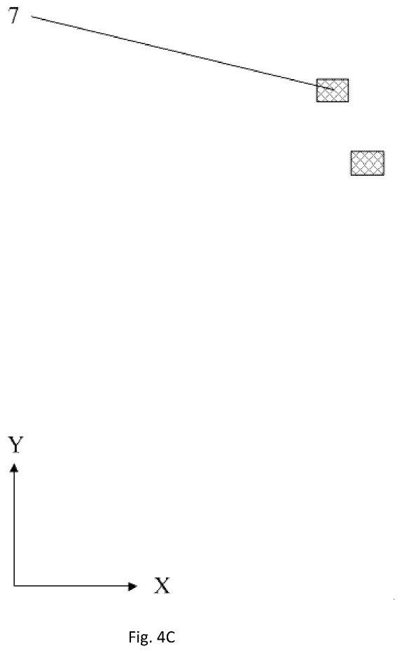

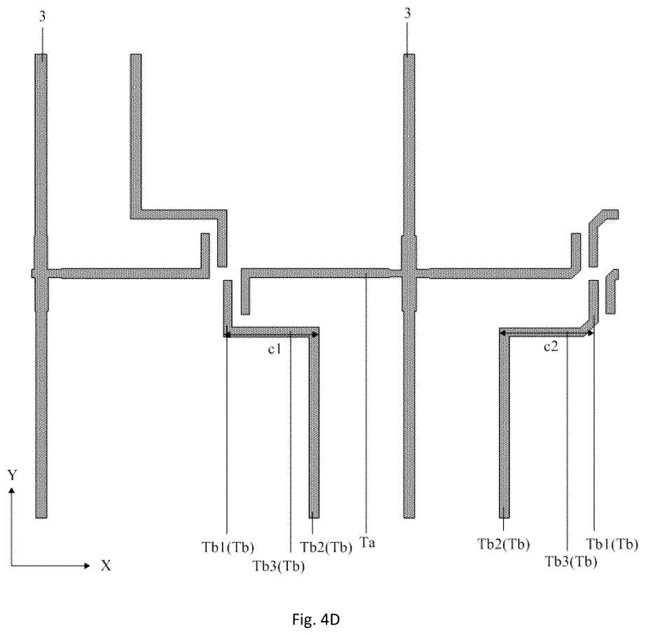

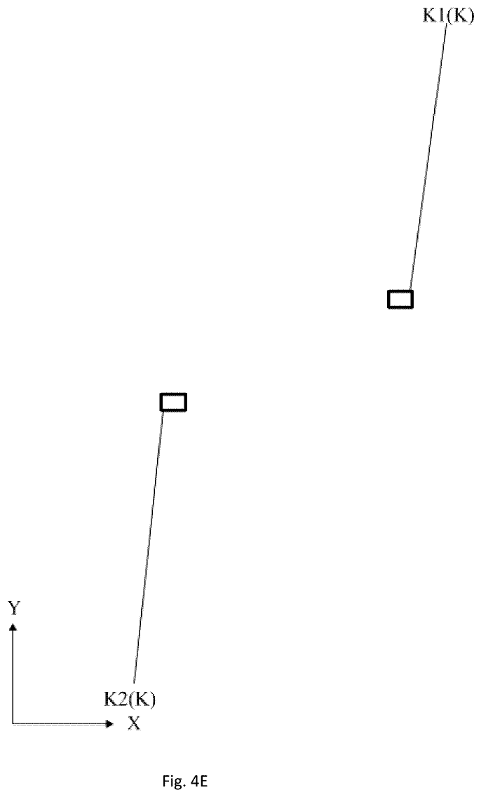

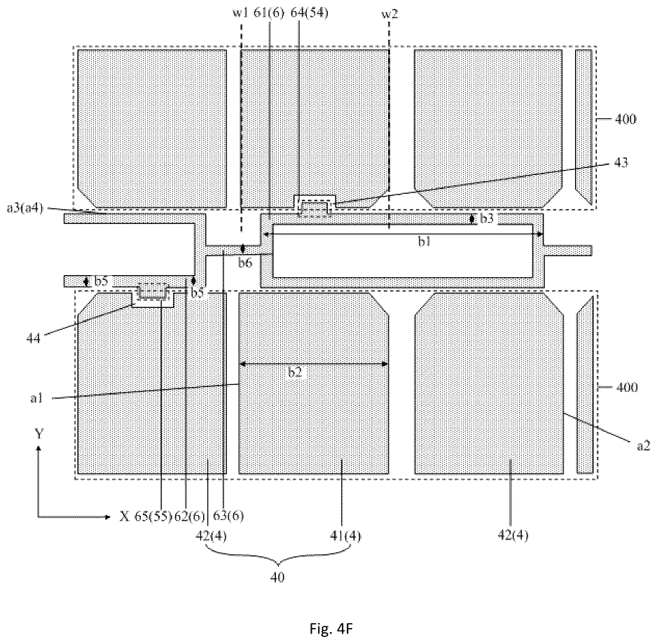

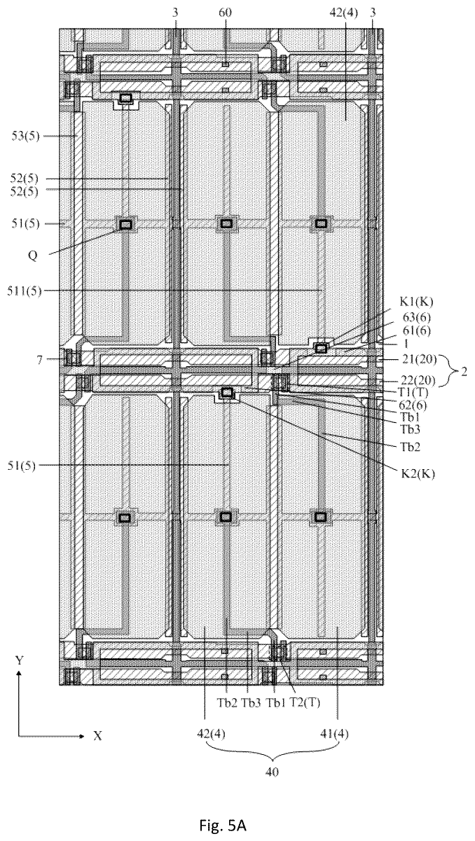

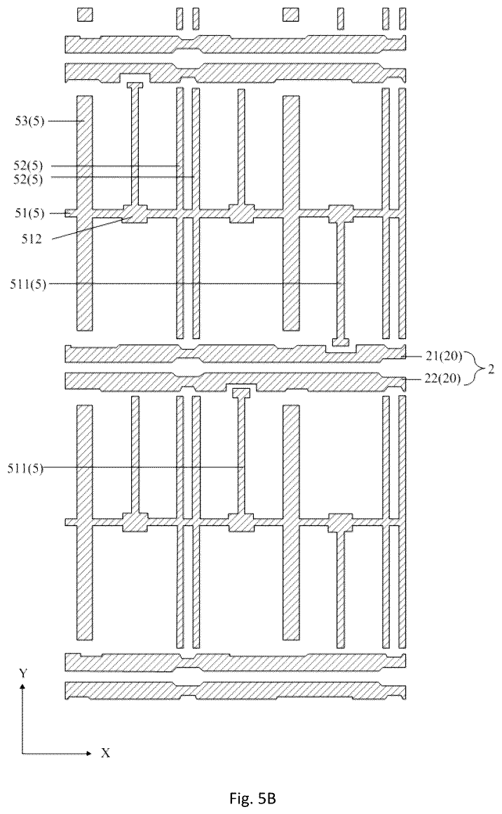

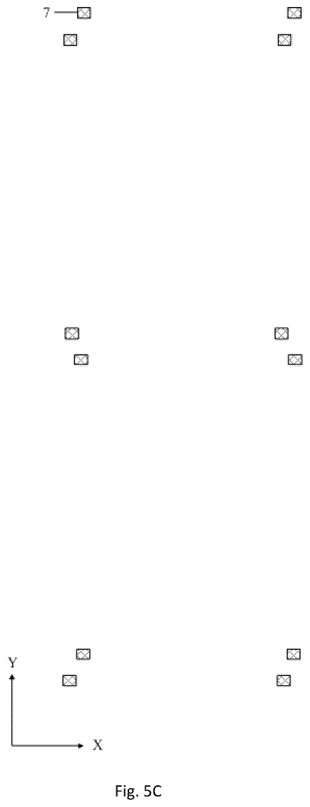

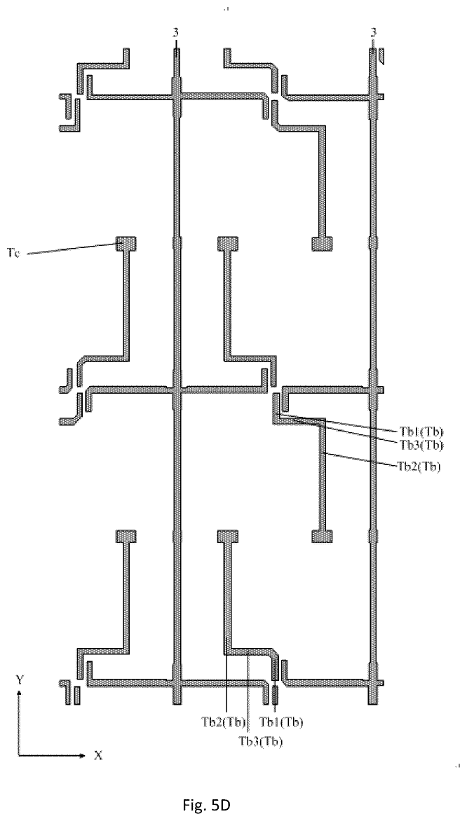

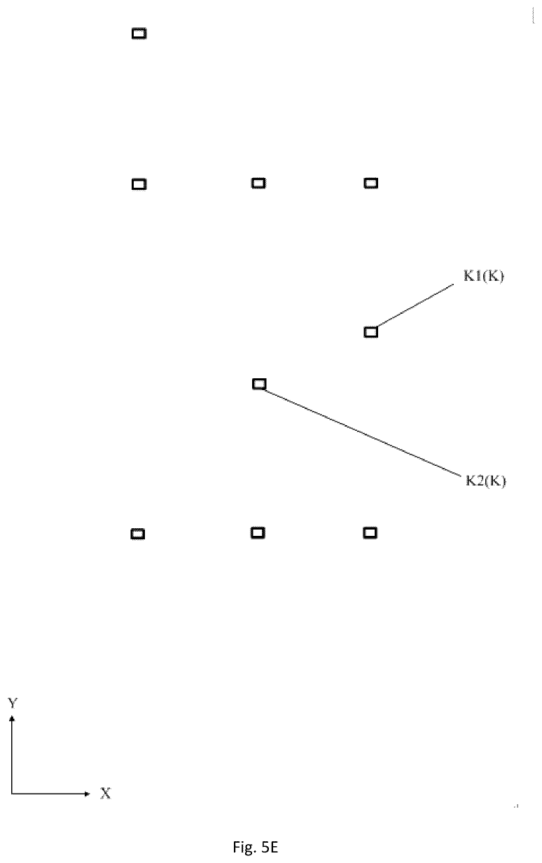

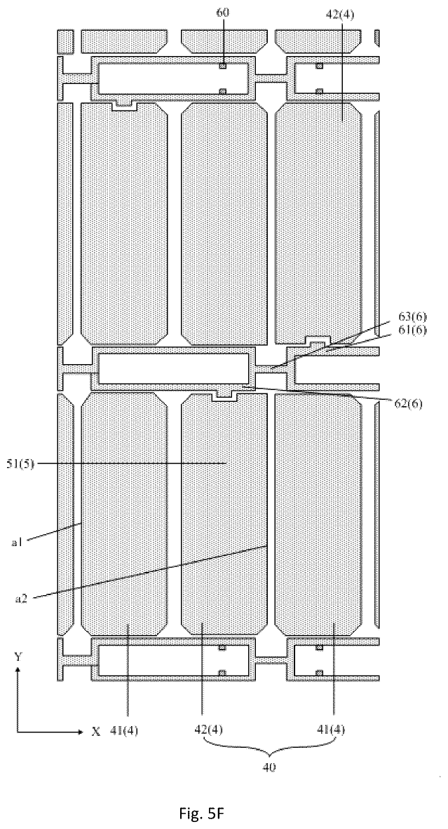

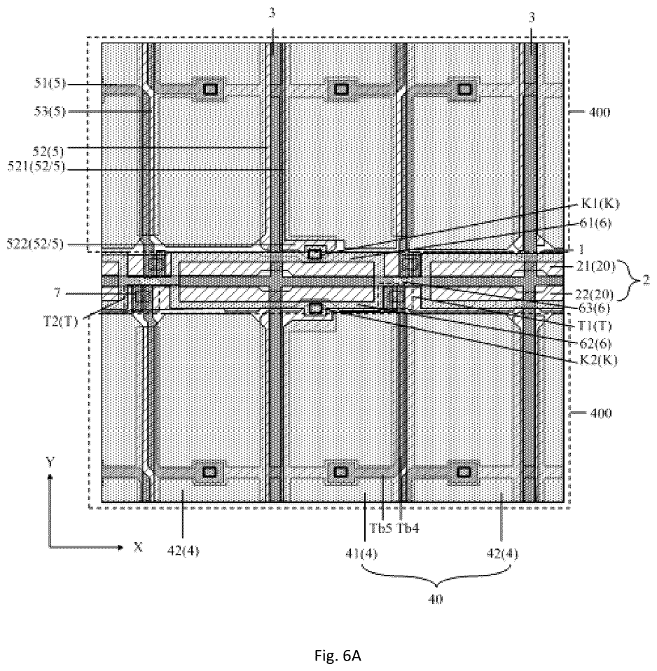

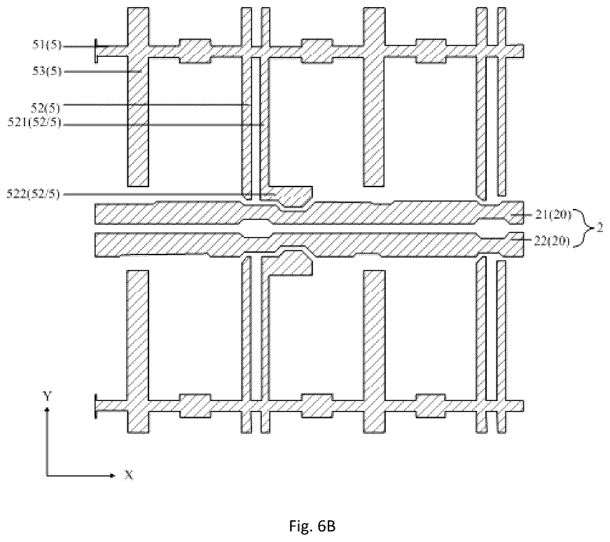

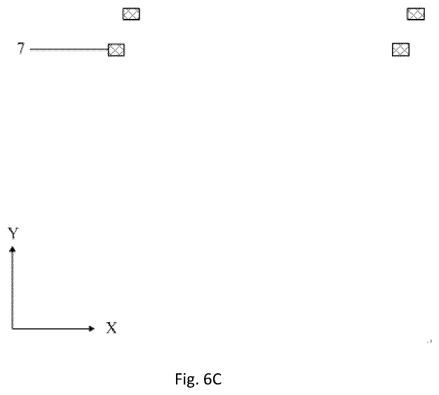

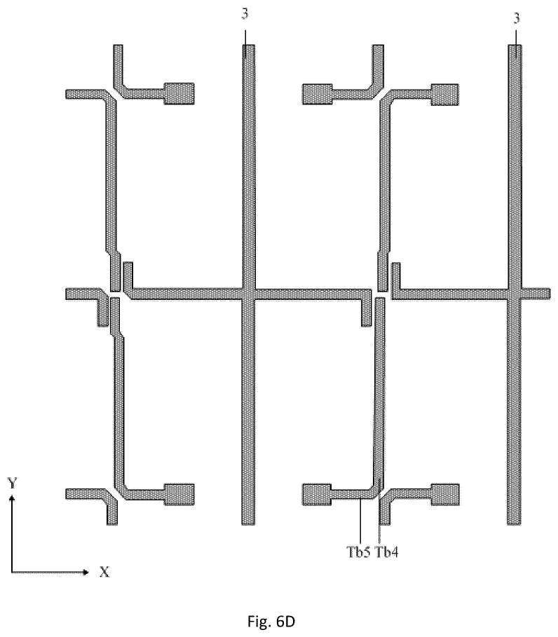

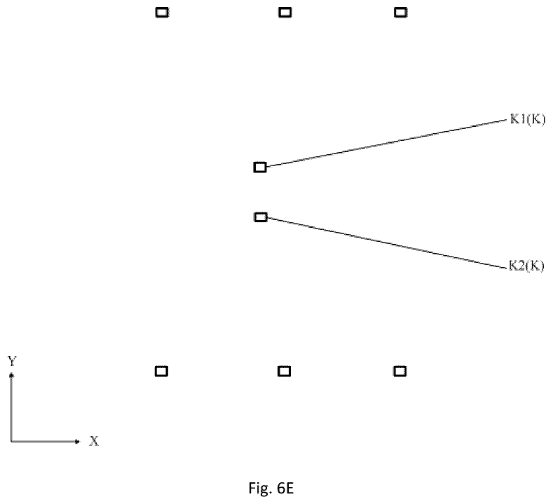

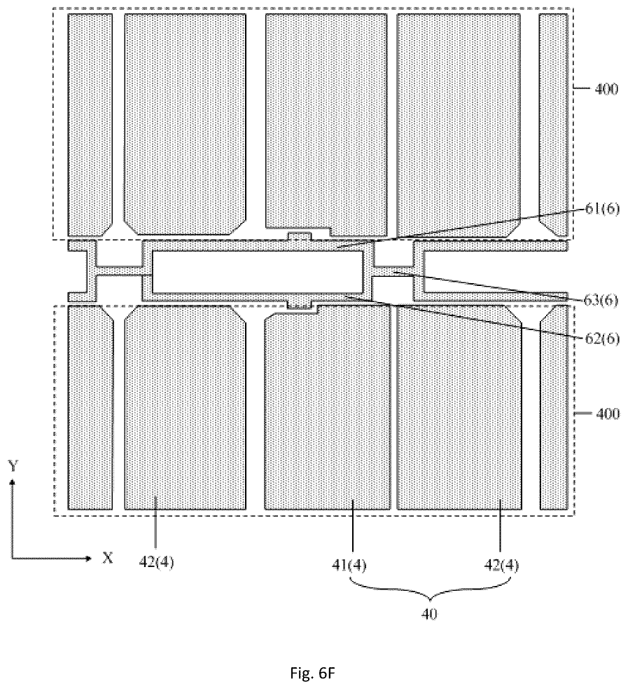

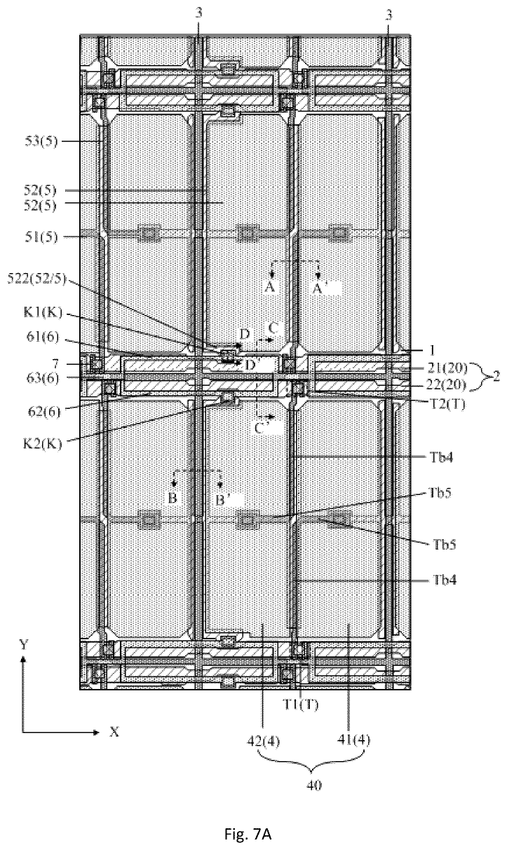

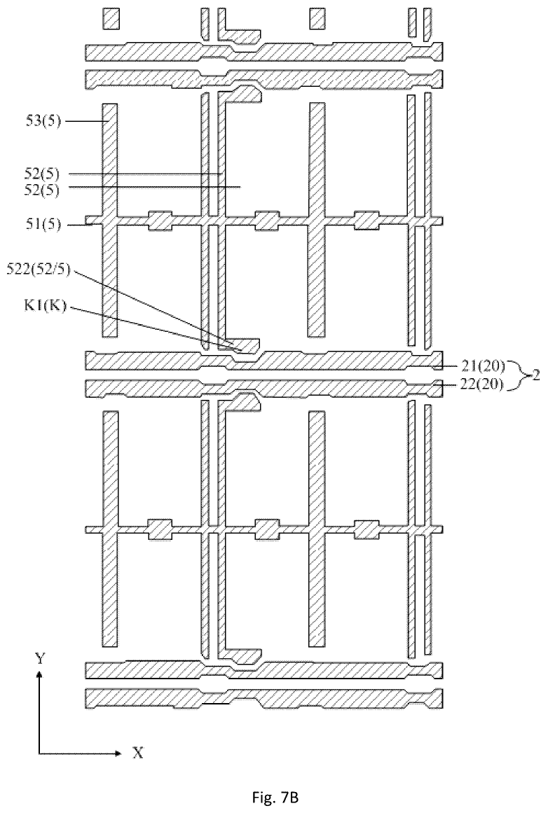

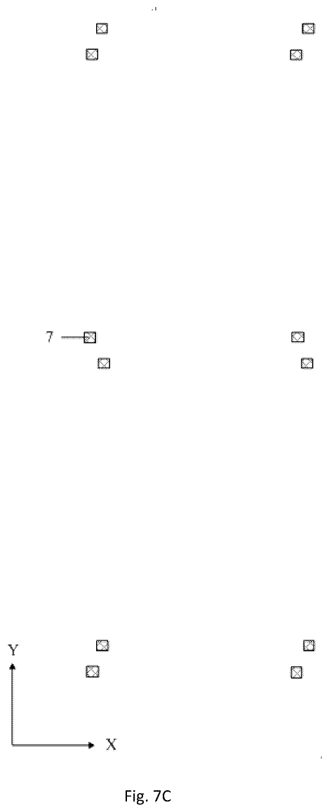

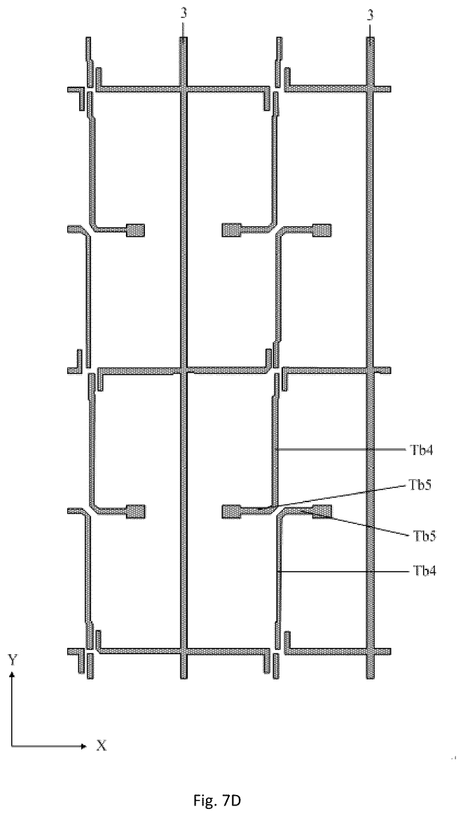

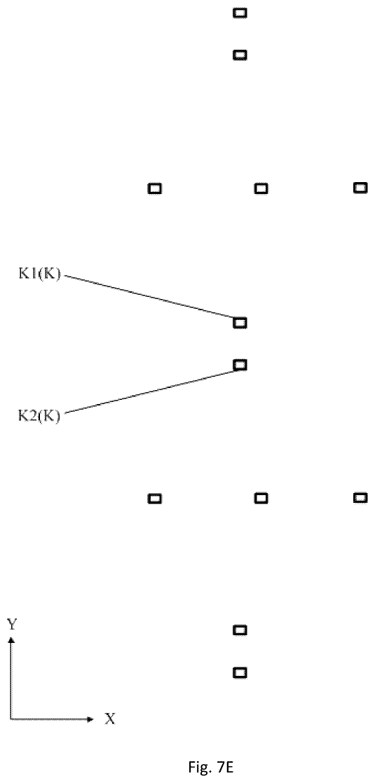

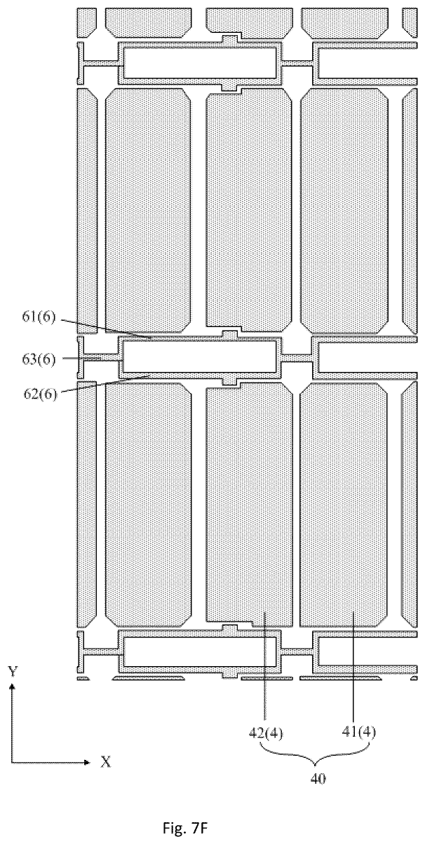

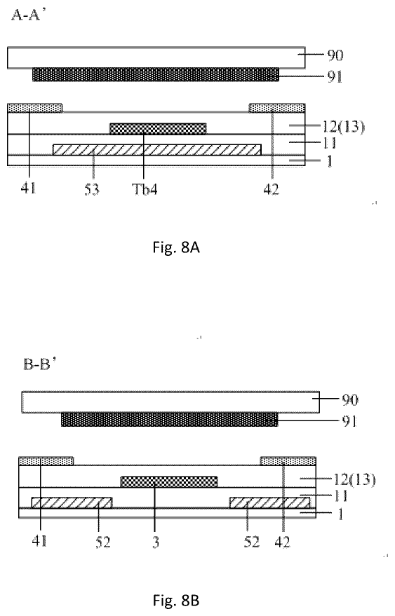

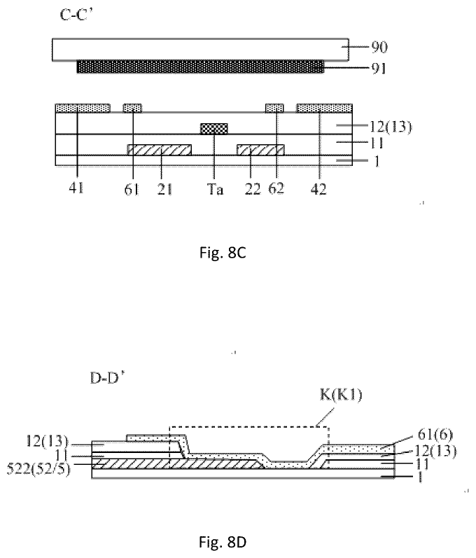

In view of the above, an array substrate is provided by embodiments of the disclosure. With reference to FIGS. 4A to 4F, 5A to 5F, 6A to 6F, 7A to 7F, and FIGS. 8A to 8C, where FIG. 4A is a first schematic diagram of an array substrate provided by embodiments of the disclosure, FIG. 4B is a schematic diagram of a single film layer where gate lines in FIG. 4A are located, FIG. 4C is a schematic diagram of a single film layer where an active layer in FIG. 4A is located, FIG. 4D is a schematic diagram of a single film layer where data lines in FIG. 4A are located, FIG. 4E is a schematic diagram of a first via hole in FIG. 4A, FIG. 4F is a schematic diagram of a single film layer where pixel electrodes in FIG. 4A are located, FIG. 5A is a second schematic diagram of an array substrate provided by embodiments of the disclosure, FIG. 5B is a schematic diagram of a single film layer where gate lines in FIG. 5A are located, FIG. 5C is a schematic diagram of a single film layer where an active layer in FIG. 5A is located, FIG. 5D is a schematic diagram of a single film layer where data lines in FIG. 5A are located, FIG. 5E is a schematic diagram of a first via hole in FIG. 5A, FIG. 5F is a schematic diagram of a single film layer where pixel electrodes in FIG. 5A are located, FIG. 6A is a third schematic diagram of an array substrate provided by embodiments of the disclosure, FIG. 6B is a schematic diagram of a single film layer where gate lines in FIG. 6A are located, FIG. 6C is a schematic diagram of a single film layer where an active layer in FIG. 6A is located, FIG. 6D is a schematic diagram of a single film layer where data lines in FIG. 6A are located; FIG. 6E is a schematic diagram of a first via hole in FIG. 6A, FIG. 6F is a schematic diagram of a single film layer where pixel electrodes in FIG. 6A are located, FIG. 7A is a fourth schematic diagram of an array substrate provided by embodiments of the disclosure, FIG. 7B is a schematic diagram of a single film layer where ate lines in FIG. 7A are located, FIG. 7C is a schematic diagram of a single film layer where an active layer in FIG. 7A is located, FIG. 7D is a schematic diagram of a single film layer where data lines in FIG. 7A are located, FIG. 7E is a schematic diagram of a first via hole in FIG. 7A, FIG. 7F is a schematic diagram of a single film layer where pixel electrodes in FIG. 7A are located, FIG. 8A is a schematic sectional view along dotted line AA′ in FIG. 7A, FIG. 8B is a schematic sectional view along dotted line BB′ in FIG. 7A, and FIG. 8C is a schematic sectional view along dotted line CC′ in FIG. 7A.

The array substrate includes:
a base substrate 1;
a plurality of gate line groups 2, where the plurality of gate line groups are arranged on one side of the base substrate 1 and extend in a first direction X, and at least one of the plurality of gate line groups 2 includes: two gate lines 20 extending in the first direction X; and specifically, the two gate lines 20 of the gate line group 2 may be a first gate line 21 and a second gate line 22 individually;
a plurality of data lines 3, where the plurality of data lines extend in a second direction Y;
a plurality of transistors T, where the plurality of transistors T may include: a plurality of first transistors T1 and a plurality of second transistors T2;
a plurality of pixel electrodes 4, where the plurality of pixel electrodes 4 include: a plurality of pixel electrode rows 400 extending in the first direction X and arranged in the second direction Y; at least one of the plurality of pixel electrode rows 400 includes: first pixel electrodes 41 and second pixel electrodes 42 that are located in regions formed by crossing the gate line groups 2 and the data lines 3 and are connected with the data lines 3 through the plurality of transistors T, and the second pixel electrodes 42 are located on one sides, away from the data lines 3 connected, of the first pixel electrodes 41; specifically, the first pixel electrodes 41 and the second pixel electrodes 42 may be connected with the same data line 3 through different transistors T, the first pixel electrodes 41 are electrically connected with the data lines 3 through the first transistors T1, and the second pixel electrodes 42 are electrically connected with the data lines 3 through the second transistors T2; and a first pixel electrode 41 and a second pixel electrode 42 that are located in the same crossing region may serve as a pixel electrode group 40;
a plurality of common wires 5, where an orthographic projection, on the base substrate 1, of at least one of the plurality of common wires 5 is located between orthographic projections, on the base substrate 1, of adjacent gate line groups 2; in other words, the plurality of common wires 5 may be located on different sides of the gate line groups 2, and the common wires 5 on different sides of the gate line groups 2 are disconnected at positions where the gate line groups 2 are located; and for example, as shown in FIG. 4B, the plurality of common wires 5 include: a first common signal extension line 511 located on an upper side of the gate line groups 2, and another first common signal extension line 511 located on a lower side of the gate line groups 2, and two first common signal extension lines 511 are disconnected at the gate line groups 2;
a plurality of connection lines 6, where the plurality of connection lines are located on the same side of the base substrate 1 and the gate line groups 2, and an orthographic projection, on the base substrate 1, of at least one of the plurality of connection lines 6 is located in an orthographic projection, on the base substrate 1, of a gap between adjacent pixel electrode rows 400; and
an insulation layer, where the insulation layer is arranged between the connection lines 6 and the common wires 5 and provided with a plurality of first via holes K, and the common wires 5 are connected with the connection lines 6 at the first via holes K, so that at least parts of the common wires 5 are electrically connected through the connection lines 6; orthographic projections, on the base substrate 1, of the first via holes K are located in orthographic projections, on the base substrate 1, of regions between two pixel edge extension lines, extending in the second direction Y, of the pixel electrodes 4; and as shown in FIG. 4A, the pixel electrodes 4 are provided with first edge extension lines w1 and second edge extension lines w2 that extend in the second direction Y, and the orthographic projections, on the base substrate 1, of the first via holes K are located in orthographic projections, on the base substrate 1, of regions between the first edge extension lines w1 and the second edge extension lines w2.

In embodiments of the disclosure, first via holes K1 for connecting the common wires 5 and the connection line are located in the orthographic projections, on the base substrate 1, of the regions between the two pixel edge extension lines, extending in the second direction Y, of the pixel electrodes 4. In other words, the first via holes are not located in regions corresponding to vertical gaps between adjacent pixel electrodes 4. Therefore, a large space is provided for arranging the first transistors T1 connected with the first pixel electrodes 41 and the second transistors T2 connected with the second pixel electrodes 42. Accordingly, coupling capacitors formed between the gate lines 20 and the first pixel electrodes 41 as well as structures connected substantially equal coupling capacitors formed between the gate lines 20 and the second pixel electrodes 42 as well as structures connected, so that the problem of shake head stripes generating in a display panel with a dual-gate lines structure has been relieved. Moreover, the connection lines 6 are located in the gaps between adjacent pixel electrode rows 400; so as to shield the connection lines from capacitors between the gate lines 20 and second electrodes Tb. Therefore, the shake head stripes generated under different impacts of process fluctuation on coupling capacitors of different pixels are relieved.

In some embodiments, as shown in FIG. 5D, at least one of the plurality of transistors T includes: a gate electrode (not shown in the figure) electrically connected with the gate line 20 (capable of serving as a gate electrode), a first electrode Ta electrically connected with the data line 3, a second electrode Tb electrically connected with the pixel electrode 4, and a connection portion Tc connected with one end of the second electrode Tb. The connection portion Tc is electrically connected with the pixel electrode 4 through a second via hole Q. The coupling capacitors formed between the gate lines 20 and the first pixel electrodes 41 as well as the structures connected may include: capacitors between the gate lines 20 and the first pixel electrodes 41, and capacitors between the gate lines 20 and second electrodes Tb of the first transistors T1. The coupling capacitors formed between the gate lines 20 and the second pixel electrodes 42 as well as the structures connected may include: capacitors between the gate lines 20 and the second pixel electrodes 42, and capacitors between the gate lines 20 and second electrodes Tb of the second transistors T2.

In some embodiments, as shown in FIGS. 4A and 4C, the transistor T may further include active layers 7. The coupling capacitors formed between the gate lines 20 and the first pixel electrodes 41 as well as the structures connected may further include: capacitors between the gate lines 20 and active layers 7 of the first transistors T1. The coupling capacitors formed between the gate lines 20 and the second pixel electrodes 42 as well as the structures connected may further include: capacitors between the gate lines 20 and active layers 7 of the second transistors T2 connected with the second pixel electrodes 42. In some embodiments, the capacitors generated between the gate lines 20 and the active layers 7 may take a role only when the transistors T are turned on. When the transistors T are turned off, it may be deemed that no capacitors are generated between the gate lines 20 and the active layers 7, avoiding affecting the coupling capacitors. For example, when the first transistors T1 start to work, the active layers 7 of the first transistors T1 are electrically connected with the second electrodes Tb, and the second electrodes Tb are electrically connected with the first pixel electrodes 41. In this case, the coupling capacitors formed between the gate lines 20 and the first pixel electrodes 41 as well as the structures connected include: the capacitors between the gate lines 20 and the first pixel electrodes 41, the capacitors between the gate lines 20 and the second electrodes Tb of the first transistors T1, and the capacitors between the gate lines 20 and the active layers 7 of the first transistors T1. When the second transistors T2 start to work, the active layers 7 are electrically connected with the second electrodes Tb of the second transistors T2, and the second electrodes Tb are electrically connected with the second pixel electrodes 42. In this case, the coupling capacitors formed between the gate lines 20 and the second pixel electrodes 42 as well as the structures connected include: the capacitors between gate lines 20 and the second pixel electrodes 42, the capacitors between the gate lines 20 and the second electrodes Tb of the second transistors T2, and the capacitors between the gate lines 20 and the active layers 7 of the second transistors T2.

It should be noted that in an actual manufacturing process, it may be difficult to make the coupling capacitors formed between the gate lines 20 and the first pixel electrodes 41 as well as the structures connected with completely equal to the coupling capacitors formed between the gate lines 20 and the second pixel electrodes 42 as well as the structures connected. Therefore, in embodiments of the disclosure, a difference between two types of coupling capacitors may range from 0 F to 0.0001 F, that is, the two types of coupling capacitors are deemed to be substantially the same. For example, the difference between the two types of coupling capacitors ranges from 0 F to 0.00007 F; or the difference between the two types of coupling capacitors is equal to 0; or, the difference between the two types of coupling capacitors is equal to 0.00007 F; or, the difference between the two types of coupling capacitors is equal to 0.000061 F; or, the difference between the two types of coupling capacitors is equal to 0.000036 F. In some embodiments, the coupling capacitance in embodiments of the disclosure may be simulated through software before the array substrate is manufactured.

In some embodiments, the active layers 5 may be made of indium gallium zinc oxide (IGZO), or amorphous silicon, low-temperature polysilicon, etc., which will not be limited herein.

In some embodiments, as shown in FIGS. 4A to 4F and 5A to 5F, the array substrate includes: first common signal lines 51 located between adjacent gate line groups 2 and extending in the first direction X, and first common signal extension lines 511 connected with one sides of the first common signal lines 51 and extending in the second direction Y. Orthographic projections, on the base substrate 1, of the first common signal lines 51 passing through centers of orthographic projection, on the base substrate 1, of the pixel electrodes 4. At least some of the first common signal extension lines 511 serve as the common wires 5.

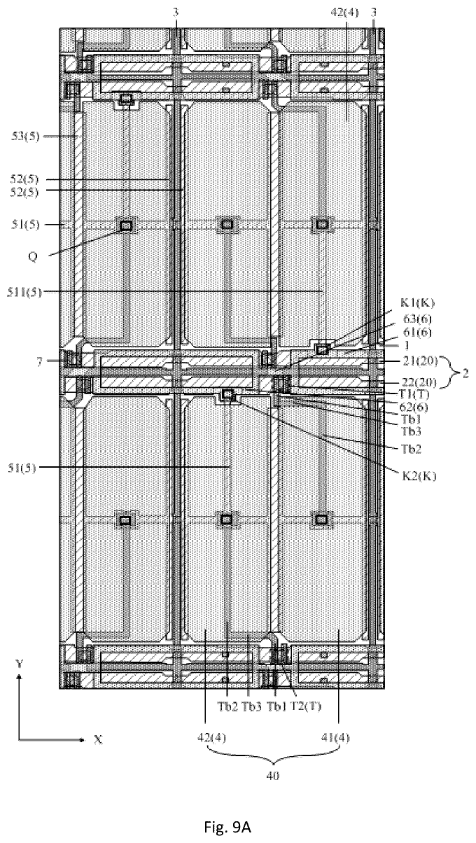

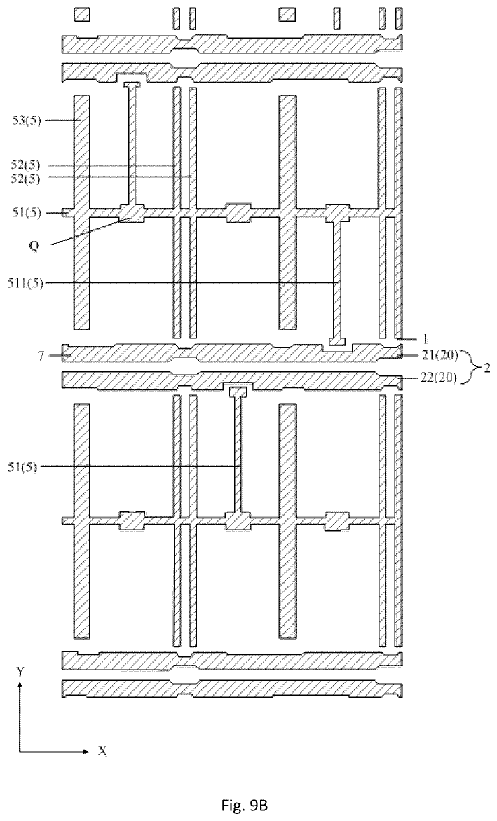

In some embodiments, as shown in FIGS. 9A and 9B, the array substrate may include first common signal extension lines 511 configured to be connected with the connection lines 6 only. In some embodiments, as shown in FIGS. 5A and 5B, the array substrate may further include first common signal extension lines 511 not configured to be connected with the connection lines 6 except for the first common signal extension lines 511 configured to be connected with the connection lines 6. As shown in FIG. 5B, two first common signal extension lines 511 located on a left side and a right side and corresponding to a second pixel electrode row are configured to be connected with the connection lines 6, and a first common signal extension line 511 in the middle is not connected with the connection line 6.

In some embodiments, as shown in FIGS. 4A to 4F, 5A to 5F, 6A to 6F, and 7A to 7F, extension lines of two first common signal extension lines 511 located on different sides of the gate line group 2 and connected through the connection line 6 may not coincide, and in other words, may be arranged in a staggered manner. For example, as shown in FIG. 4A, the first common signal extension line 511 located on an upper side of the gate line group 2 and the first common signal extension line 511 located on a lower side of the gate line group 2 are not located in the same vertical direction, so as to avoid the second electrode Tb of the transistor T.

In some embodiments, as shown in FIGS. 5A to 5F, 6A to 6F, and 7A to 7F, the array substrate further includes: common electrode portions 512 connected with the first common signal lines 51, where orthographic projections, on the base substrate 1, of the common electrode portions 512 cover orthographic projections, on the base substrate 1, of the connection portions Tc. In this way, first storage capacitors are formed between the common electrode portions 60 and the connection portions Tc.

In some embodiments, as shown in FIGS. 5A to 5F, 6A to 6F, and 7A to 7F, shapes of the orthographic projections, on the base substrate 1, of the common electrode portions 512 are similar to shapes of the orthographic projections, on the base substrate 1, of the connection portions Tc. Centers of the orthographic projections of the common electrode portions 512 on the base substrate 1 coincide with centers of the orthographic projections of the connection portions Tc on the base substrate 1.

In some embodiments, as shown in FIGS. 6A to 6F, 7A to 7F, and 8A to 8C, the array substrate includes: second common signal line groups located between adjacent gate line groups 2 and extending in the second direction Y, where the second common signal line groups each include two second common signal lines 52 located on different sides of the data line 3 individually; at least one of the second common signal lines 52 includes: a primary portion 521 of the second common signal line extending in the second direction Y, and a branch portion 522 of the second common signal line extending from one end of the primary portion 521 of the second common signal line in the first direction X; and at least some of the second common signal lines 52 serve as the common wires, and the second common signal lines 52 are electrically connected with the connection lines 6 through the branch portion 522 of the second common signal line.

In some embodiments, as shown in FIGS. 6A to 6F, 7A to 7F, and 8A to 8C, the branch portion 522 of the second common signal line located on different sides of the gate line group 2 extend in the same direction. For example, as shown in FIG. 6A, the branch portion 522 of the second common signal line on the upper side of the gate line group 2 extends rightwards, and the branch portion 522 of the second common signal line on the lower side of the gate line group 2 also extends rightwards. In this way, the two branch portions 522 of the second common signal line on different sides of the gate line group 2 are conveniently connected with each other nearby.

In some embodiments, the branch portion 522 of the second common signal line located on different sides of the gate line group 2 have the same extension length in the first direction X. In some embodiments, the extension length of the branch portion 522 of the second common signal line located on different sides of the gate line group 2 in the first direction X is one quarter to three quarters of an extension length of the pixel electrode 4 in the first direction X. In some embodiments, the extension length of the branch portion 522 of the second common signal line located on different sides of the gate line group 2 in the first direction X is one half of the extension length of the pixel electrode 4 in the first direction X.

In some embodiments, the branch portion 522 of the second common signal line may be arranged at two ends of the same primary portion 521 of the second common signal line in an extension direction. Two branch portions 522 of the second common signal line connected with the same primary second common signal line portion 521 extend towards the same side. As shown in FIG. 6A, the two branch portions 522 of the second common signal line connected with the same primary portion 521 of the second common signal line extend towards the right side.

In some embodiments, the branch portions 522 of the second common signal line located on different sides of the gate line groups 2 are connected with the primary portion 521 of the second common signal line located on the same sides of the data lines 3. For example, as shown in FIG. 6A, the branch portion 522 of the second common signal line located on the upper side of the gate line group 2 is connected with the primary portion 521 of the second common signal line located on a right side of the data line 3, and the branch portion 522 of the second common signal line located on the lower side of the gate line group 2 is also connected with the primary portion 521 of the second common signal line located on the right side of the data line 3.

In some embodiments, as shown in FIGS. 6A to 6F, 7A to 7F, and 8A to 8C, orthographic projections, on the base substrate 1, of the second common signal lines 52 at least partially overlap the orthographic projections, on the base substrate 1, of the pixel electrodes 4. In this way, second storage capacitors are formed between the second common signal lines 52 and the pixel electrodes 4.

In some embodiments, as shown in FIGS. 4A to 4F, 5A to 5F, 6A to 6F, and 7A to 7F, the array substrate includes: third common signal lines 53 located between adjacent gate line groups 2 and extending in the second direction Y. The orthographic projection of the third common signal line 53 on the base substrate 1 is located between the orthographic projection of the first pixel electrodes 41 on the base substrate 1 and the orthographic projection of the second pixel electrodes 42 on the base substrate 1.

In some embodiments, as shown in FIGS. 4A and 4B, the orthographic projections, on the base substrate 1, of the third common signal lines 53 partially overlap the orthographic projections, on the base substrate 1, of the pixel electrodes 4. In this way, third storage capacitors are formed between the third common signal lines 53 and the pixel electrodes 4.

In some embodiments, as shown in FIGS. 4A to 4F, 5A to 5F, 6A to 6F, and 7A to 7F, the second common signal lines 52 between adjacent gate line groups 2 and the third common signal lines 53 between adjacent gate line groups are electrically connected with the first common signal lines 51.

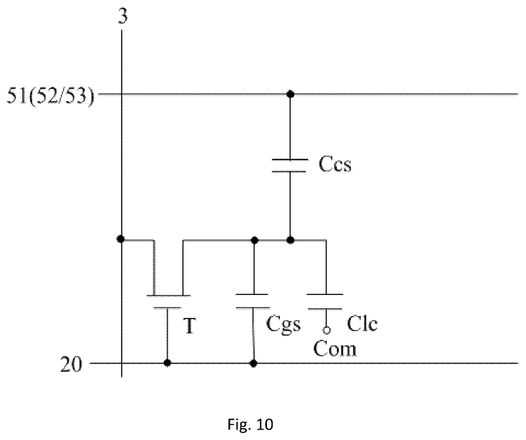

In some embodiments, as shown in FIG. 10, the first storage capacitors, the second storage capacitors, and the third storage capacitors may constitute a storage capacitor (Ccs). Drains (i.e. the second electrodes Tb) of the transistors T as well as structures (for example, the pixel electrodes 4 and the active layers 7) electrically connected with the drains and the gate lines 20 may form coupling capacitors (Cgs). Liquid crystals of the array substrate and liquid crystal of an opposite substrate may form liquid crystal capacitors (Clc).

In some embodiments, as shown in FIGS. 4A and 4D, the first common signal extension lines 511 serve as the common wires 5. The second electrodes Tb, connected with the first pixel electrodes 41, of the transistors T and the second electrodes Tb, connected with the second pixel electrodes 42, of the transistors T (i.e. the first transistors T1) are symmetrical with respect to the data lines 3 (optionally, the first pixel electrodes 41 and the second pixel electrodes 42 may not be connected with the same data lines 3, and the first pixel electrodes 41 and the second pixel electrodes 42 are alternately arranged in a row direction; and for example, the first pixel electrodes 41 and the second pixel electrodes 42 are arranged alternatively and sequentially in an order of the first pixel electrode 41, the second pixel electrode 42, the first pixel electrode 41, the second pixel electrode 42 and so on). In some embodiments, as shown in FIGS. 4A and 4D, the second electrodes Tb, connected with the first pixel electrodes 41, of the transistors T (i.e. the second transistors T2) and the second electrodes Tb, connected with the second pixel electrodes 42, of the transistors T have the same pattern, shape, and size. In some embodiments, for example, the second electrodes Tb of the first transistors T1 and the second electrodes Tb of the second transistors T2 each include: first portions Tb1 and second portions Tb2 that extend in the second direction Y and have extension lines not overlapping each other, and third portions Tb3 that extend in the first direction X and connect the first portions Tb1 and the second portions Tb2. The first portions Tb1 of the first transistors T1 and the first portions Tb1 of the second transistors T2 have the same width in the first direction X and the same length in the second direction Y. The second electrodes Tb2 of the first transistors T1 and the second electrodes Tb2 of the second transistors T2 have the same width in the first direction X and the same length in the second direction Y. The third portions Tb3 of the first transistors T1 and the third portions Tb3 of the second transistors T2 have the same length in the first direction X and the same width in the second direction Y. In some embodiments, minimum distances between the third portions Tb3 of the first transistors T1 and the gate lines 20 in the second direction Y are the same as minimum distances between the third portions Tb3 of the second transistors T2 and the gate lines 20 in the second direction Y.

In some embodiments, as shown in FIGS. 4A and 4D, a length c1 of the third portions Tb3, connected with the first pixel electrodes 41, of the transistors T substantially equals a length c2 of the third portions Tb3, connected with the second pixel electrodes 42, of another transistors T.

In some embodiments, as shown in FIGS. 4A, 4D, 5A, and 5D, orthographic projections, on the base substrate 1, of extension lines of the first portions Tb1, connected with the first pixel electrodes 41, of the transistors T (i.e. the first transistors T1) are located in the orthographic projections, on the base substrate 1, of the gap between adjacent pixel electrodes 4. That is, the first transistors T1 may be arranged at positions that correspond to vertical gaps between adjacent pixel electrodes 4 and are substantially the same as positions for arranging the second transistors T2. Therefore, a length of the third portions Tb3 of the first transistors T1 in the first direction X may substantially equal a length of the third portions Tb3 of the second transistors T2 in the first direction X. In some embodiments, orthographic projections, on the base substrate 1, of extension lines of the first portions Tb1, connected with the second pixel electrodes 42, of the transistors T (i.e. the second transistors T2) are located in the orthographic projections, on the base substrate 1, of the gaps between adjacent pixel electrodes 4.

In some embodiments, as shown in FIGS. 4A to 4F, 5A to 5F, 6A to 6F, and 7A to 7F, the orthographic projections, on the base substrate 1, of the second portions Tb2 have overlapping regions with the orthographic projections, on the base substrate 1, of the pixel electrodes 4. In some embodiments, the second portions Tb2 extend in the second direction Y, and the orthographic projections, on the base substrate 1, of the second portions penetrate the centers of the pixel electrodes 4, so as to substantially coincide with vertical dark stripes of the display panel in the middles of the pixel electrodes 4. Therefore, the situation that the vertical dark stripes in the middles are thick as a whole, affecting an aperture ratio of the display panel when the orthographic projections do not coincide with the vertical dark stripes is avoided.

In some embodiments, as shown in FIGS. 6A to 6F and 7A to 7F, the second common signal lines 52 serve as the common wires. The second electrodes Tb include: fourth portions Tb4 extending in the second direction Y, and fifth portions Tb5 extending in the first direction X and connected with one ends of the fourth portions Tb4. Orthographic projections, on the base substrate 1, of the fourth portions Tb4 have overlapping regions with the orthographic projections, on the base substrate 1, of the gaps between adjacent pixel electrodes 4. In other words, the fourth portions Tb4 of the first transistors T1 and the fourth portions Tb4 of the second transistors T2 are arranged at the vertical gaps between adjacent pixel electrodes 4 (that is, no portions that are similar to the third portions Tb3 close to the gate lines 20 and extending in the first direction X in FIG. 4A are arranged, so that the capacitors between the gate lines 20 and the third portions Tb3 can be reduced or eliminated). Accordingly, the problem of the shake head stripes generating in the display panel with the dual-gate lines structure is relieved.

In some embodiments, as shown in FIGS. 6A to 6F and 7A to 7F, the fourth portions Tb4 of the first transistors T1 and the fourth portions Tb4 of the second transistors T2 may be located at the vertical gaps between the first pixel electrodes 41 and the second pixel electrodes 42. The fifth portions Tb5 of the first transistors T1 may extend from end portions of the fourth portions Tb4 in a direction close to one sides of the data lines 3 connected with the first transistors T1. The fifth portions Tb5 of the second transistors T2 may extend from end portions of the fourth portions Tb4 in a direction far away from one sides of the data lines 3 connected with the second transistors T2.

In some embodiments, as shown in FIGS. 6A to 6F and 7A to 7F, the fifth portions Tb5 of the first transistors T1 extend in the first direction X, and orthographic projections, on the base substrate 1, of the fifth portions penetrate central regions of the pixel electrodes 4. The fifth portions Tb5 of the second transistors T1 extend in the first direction X, and orthographic projections, on the base substrate 1, of the fifth portions penetrate the central regions of the pixel electrodes 4.

In some embodiments, as shown in FIGS. 6A to 6F and 7A to 7F, an extension length of the fourth portions Tb4 in the second direction Y may be one quarter to three quarters of a length of the pixel electrodes 4 in the second direction Y, for example, the extension length of the fourth portions Tb4 in the second direction Y is one half of a length of the pixel electrodes 4 in the second direction Y. In some embodiments, an extension length of the fifth portions Tb5 in the first direction X may be one quarter to three quarters of the length of the pixel electrodes 4 in the first direction X, for example, the extension length of the fifth portions Tb5 in the first direction X is one half of the length of the pixel electrodes 4 in the first direction X.

In some embodiments, the extension length of the fourth portions Tb4 of the first transistors T1 in the second direction Y substantially equals the extension length of the fourth portions Tb4 of the second transistors T2 in the second direction Y. In some embodiments, the extension length of the fifth portions Tb5 of the first transistors T1 in the first direction X substantially equals the extension length of the fifth portions Tb5 of the second transistors T2 in the first direction X.

In some embodiments, as shown in FIG. 4A, the pixel electrodes 4 are provided with first symmetry axes L extending in the second direction Y and penetrating the central regions of the pixel electrodes 4, where the first symmetry axes L penetrate central regions of the first via holes K. In other words, the first via holes K are located in regions corresponding to the centers of the pixel electrodes 4. Therefore, a large space is provided for arranging the first transistors T1 connected with the first pixel electrodes 41 and the second transistors T2 connected with the second pixel electrodes 42.

In some embodiments, as shown in FIGS. 4A to 4F, 5A to 5F, 6A to 6F, and 7A to 7F, the orthographic projections, on the base substrate 1, of the first via holes K are located in the orthographic projections, on the base substrate 1, of the gaps between adjacent pixel electrode rows 400. In this way, the situation that normal display of the display panel is affected when the first via holes K1 are provided in regions where the pixel electrodes 4 are located is avoided.

In some embodiments, as shown in FIGS. 4A to 4F, 5A to 5F, 6A to 6F, and 7A to 7F, the first via holes K include: first via sub-holes K1 and second via sub-holes K2. The connection line 6 include: a first connection sub-line 61 and a second connection sub-line 62 that extend in the first direction X. In some embodiments, as shown in FIGS. 4A and 4E, the extension line of the first connection sub-line 61 and the extension line of the second connection sub-line 62 may not coincide with each other and may be arranged in the first direction X in a staggered manner instead of being located in the same extension direction. In some embodiments, an orthographic projection, on the base substrate 1, of the first connection sub-line 61 may partially overlap orthographic projection, on the base substrate 1, of the first gate line 21, and do not overlap the orthographic projection, on the base substrate 1, of the second gate line 22. The orthographic projection, on the base substrate 1, of the second connection sub-line 62 may partially coincide the orthographic projection, on the base substrate 1, of the second gate line 22, and do not overlap the orthographic projection, on the base substrate 1, of the first gate line 21. The first connection sub-line 61 is electrically connected with common wires 5 on one side of the gate line group 2 through the first via sub-hole K1. The second connection sub-line 62 is electrically connected with the common wire 5 on the other side of the gate line group 2 through the second via sub-hole K1.

In some embodiments, as shown in FIG. 8D, a schematic sectional view along dotted line DD′ in FIG. 7A, the first via holes K may be semi-hanging holes. In some embodiments, the first via holes K are partially exposed to the common wires 5 and partially exposed to the base substrate 1. The connection lines 6 make partial contact with the common wires 5 and partial contact with the base substrate 1 at the first via holes K. In embodiments of the disclosure, the common wires 5 are connected with the connection lines 6 through the semi-hanging holes, so that step structures are formed inside the first via holes K. Accordingly, an alignment liquid is guided and prevented from being uneven, and the uniformity of the alignment liquid on the array substrate is improved to avoid moire stripes on the screen, so that a display quality is improved.

In some embodiments, as shown in FIGS. 8A to 8D, the insulation layer may include one or a combination of film layers as follows:
a gate line insulation layer 11;
a passivation layer 12; or
a planarization layer 13.

In some embodiments, the planarization layer 13 may be an organic film layer. In some embodiments, the passivation layer 12 may be a polyvinyl chloride (PVX) layer, for example, a silicon nitride material layer.

In some embodiments, as shown in FIGS. 4A to 4F, the first connection sub-line 61 is provided with a first protrusion 64 protruding towards one side of the pixel electrode 4, and the common wire 5 is provided with a second protrusion 54 protruding towards one side of the gate line group 2; the orthographic projection, on the base substrate 1, of the first protrusion 64 has a first overlapping region with an orthographic projection, on the base substrate 1, of the second protrusion 54, and the first protrusion is connected with the second protrusion through the first via sub-hole K1 in the first overlapping region; the second connection sub-line 62 is provided with a third protrusion 65 protruding towards one side of the pixel electrode 4, and the common wire 5 is provided with a fourth protrusion 55 protruding towards one side of the gate line group 2; and the orthographic projection, on the base substrate 1, of the third protrusion 65 has a second overlapping region with the orthographic projection, on the base substrate 1, of the fourth protrusion 55, and the third protrusion is connected with the fourth protrusion through the second via sub-hole K2 in the second overlapping region.

In some embodiments, when the first common signal extension lines 511 serve as the common wires 5, the second protrusion 54 and the fourth protrusion 55 may be end portions connected with the first common signal extension lines 511. When the second common signal lines 52 serve as the common wires, the second protrusion 54 and the fourth protrusion 55 may be end portions connected with the secondary second common signal line portions 52.

In some embodiments, as shown in FIGS. 4A to 4F, the pixel electrodes 4 are provided with a first recess 43 at a position opposite the first protrusion 64, and a gap is provided between an orthographic projection, on the base substrate 1, of the first recess 43 and the orthographic projection, on the base substrate 1, of the first protrusion 64; the gate line 20 is provided with a second recess 23 at a position opposite the second protrusion 54, and a gap is provided between the orthographic projection, on the base substrate 1, of the second recess 23 and the orthographic projection, on the base substrate 1, of the second protrusion 54; the pixel electrode 4 is provided with a third recess 44 at a position opposite the third protrusion 65, and a gap is provided between the orthographic projection, on the base substrate 1, of the third recess 44 and the orthographic projection, on the base substrate 1, of the third protrusion 65; and the gate line 20 is provided with a fourth recess 24 at a position opposite the fourth protrusion 55, and a gap is provided between the orthographic projection, on the base substrate 1, of the fourth recess 24 and the orthographic projection, on the base substrate, of the fourth protrusion 54.

In some embodiments, as shown in FIGS. 4A to 4F, 5A to 5F, 6A to 6F, and 7A to 7F, the connection lines 6 include: a plurality of connection rings sequentially distributed in the first direction, and serial connection portions 63 connecting adjacent connection rings; and the connection ring include the first connection sub-line 61 and the second connection sub-line 62. In this way, the capacitors between the gate lines 20 and the second electrodes Tb can be blocked through the connection rings. Accordingly, the shake head stripes generated under different impacts of process fluctuation on the coupling capacitors of different pixels can be relieved.

In some embodiments, as shown in FIGS. 5A and 5F, the array substrate further includes: in-ring bumps 60 located in the connection rings, where the in-ring bumps 60 may be configured to identify specific positions of pixels. For example, the in-ring bumps 60 are configured to identify positions of red pixels, positions of green pixels, or positions of blue pixels.

In some embodiments, as shown in FIGS. 4A to 4F and 5A to 5F, the first via sub-holes K1 and the second via sub-holes K2 are located in different connection rings.

In some embodiments, as shown in FIGS. 6A to 6F and 7A to 7F, the first via sub-holes K1 and the second via sub-holes K2 are located in the same connection ring.

In some embodiments, as shown in FIGS. 4F and 5F, the first pixel electrodes 41 is provided with a first outer edge a1 on one side far away from the second pixel electrode 42 and extending in the second direction Y, and the second pixel electrode 42 is provided with a second outer edge a2 on one side far away from the first pixel electrode 41 and extending in the second direction Y; and the orthographic projection, on the base substrate 1, of the connection rings is located in the orthographic projection, on the base substrate 1, of a region between the extension line of the first outer edge a1 and the extension line of the second outer edge a2.

In some embodiments, as shown in FIGS. 4A to 4F, a length b1 of the connection rings in the first direction X is 1 time to 2 times of a length b2 of the pixel electrodes 4 in the first direction X. A minimum line width b3 of the first connection sub-line 61 is smaller than a maximum width b4 of the gate lines 20 in the second direction Y. A minimum line width b5 of the second connection sub-line 62 is smaller than the maximum width b4 of the gate lines 20 in the second direction Y. A line width b6 of the serial connection portions 63 is smaller than the maximum width b4 of the gate lines 20 in the second direction Y.

In some embodiments, as shown in FIGS. 4A to 4F, 5A to 5F, 6A to 6F, and 7A to 7F, the orthographic projection, on the base substrate 1, of the outer edge a3 of the connection ring in the first direction X partially overlaps with the orthographic projection, on the base substrate 1, of the outer edge a4 of the gate line 20 towards the pixel electrodes 4. In this way, the capacitors between the gate lines 20 and the second electrodes Tb can be blocked through the connection lines 6. Accordingly, the shake head stripes generated under different impacts of process fluctuation on the coupling capacitors of different pixels can be relieved.

In some embodiments, the connection lines 6 and the pixel electrodes 4 are located in the same layer and made of the same material. In this way, the connection lines 6 and the pixel electrodes 4 are formed simultaneously. Therefore, a process for manufacturing the display panel is simplified, and a manufacturing cost of the display panel is reduced.

In some embodiments, the common wires 5 and the gate lines 20 are located in the same layer and made of the same material. In this way, the common wires 5 and the gate lines 20 are formed simultaneously. Therefore, the process for manufacturing the display panel is simplified, and the manufacturing cost of the display panel is reduced.

Based on the same inventive concept, a display panel is further provided by embodiments of the disclosure. The display panel includes the array substrate according to embodiments of the disclosure and further includes an opposite substrate arranged opposite to the array substrate, where a common electrode layer is arranged on one side of the opposite substrate facing the array substrate.

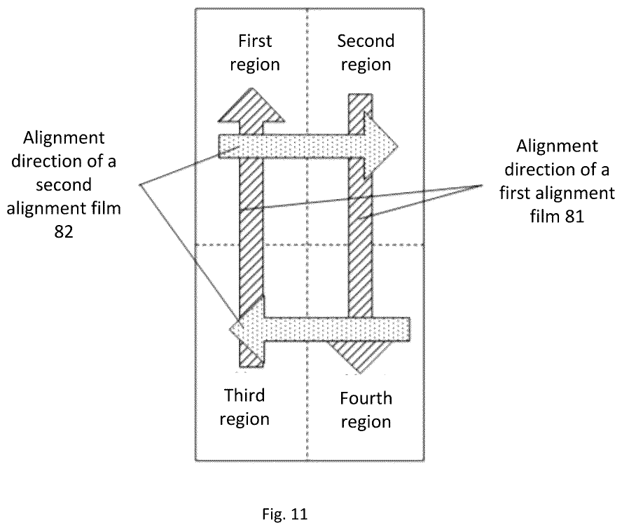

In some embodiments, a liquid crystal layer may be arranged between the array substrate and the opposite substrate, where the liquid crystal layer is provided with a plurality of liquid crystal regions in regions where pixel electrodes 4 are located, and portions, in different liquid crystal regions, of the liquid crystal layer have different alignment in an initial state. In some embodiments, as shown in FIG. 11, for example, the liquid crystal layer is provided with four liquid crystal regions in the regions where the pixel electrodes 4 are located, and orthographic projection, on a base substrate 1, of the four liquid crystal regions may be located in a first region and a second region that are located on one side of an orthographic projection, on the base substrate 1, of a first common signal line 51, and a third region and a fourth region that are located on the other side of the orthographic projection, on the base substrate 1, of the first common signal line 51 respectively. In some embodiments, the array substrate may be provided with a first alignment film layer 81, and the opposite substrate may be provided with a second alignment film layer 82. Alignment of the first alignment film layer 81 and alignment of the second alignment film layer 82 in different regions may be shown in FIG. 11. The alignment of the first alignment film layer 81 may be perpendicular to the alignment of the second alignment film layer 82.

In some embodiments, the initial state of the portions, in different liquid crystal regions, of the liquid crystal layer may be understood as a deflection state of the portions, in different liquid crystal regions, of the liquid crystal layer when no electric field is applied, i.e., a state generated when no voltage is formed between the pixel electrodes 4 and common electrodes.

In some embodiments, as shown in FIGS. 8A, 8B, and 8C, the opposite substrate may further include an opposite base substrate 90, and a black matrix layer 91 and a colored filter layer (not shown in the figures) that are located on one side of the opposite base substrate 90. Optionally, in a direction perpendicular to the base substrate, the black matrix layer covers data lines and second common signal lines located on two sides of the data lines and extending in a second direction, and may cover the pixel electrodes in all or at least in part. The opposite substrate may further include a common electrode layer on one side, away from the base substrate, of the colored filter layer. Optionally, the common electrode layer of the opposite substrate and common wires arranged on the array substrate transmit the same common signal. Optionally, the common wires may transmit a signal different from a signal of the common electrode layer of the opposite substrate.

In some embodiments, in order to reduce the number of masks, the data lines 3 and active layers 5 may be formed by performing a mask process once. In other words, one side of the data line 3 facing the base substrate 1 may be further provided with an active layer (the active layer may be made of amorphous silicon, low-temperature polysilicon, metal oxide, etc.).

Based on the same inventive concept, a display device is further provided by embodiments of the disclosure. The display device includes the display panel according to embodiments of the disclosure.

While the preferred embodiments of the disclosure have been described, those skilled in the art can make additional changes and modifications to these embodiments once they learn the basic creative concepts. Therefore, the appended claims are intended to be interpreted as including the preferred embodiments and all changes and modifications falling within the scope of the disclosure.

Evidently those skilled in the art can make various modifications and variations to the present disclosure without departing from the spirit and scope of the present disclosure. Thus the present disclosure is also intended to encompass these modifications and variations therein as long as these modifications and variations to the present disclosure come into the scope of the claims of the present disclosure and their equivalents.

1. An array substrate, comprising:
a base substrate;
a plurality of gate line groups, wherein the plurality of gate line groups are arranged on a side of the base substrate and extend in a first direction, and at least one of the plurality of gate line groups comprises: two gate lines extending in the first direction;
a plurality of data lines, wherein the plurality of data lines extend in a second direction;
a plurality of transistors;
a plurality of pixel electrodes, wherein the plurality of pixel electrodes comprise: a plurality of pixel electrode rows extending in the first direction and arranged in the second direction; and at least one of the plurality of pixel electrode rows comprises: first pixel electrodes and second pixel electrodes that are located in regions formed by crossing the gate line groups and the data lines and are connected with the data lines through the plurality of transistors, and the second pixel electrodes are located on one sides of the first pixel electrodes far away from the data lines connected;
a plurality of common wires, wherein the plurality of common wires are arranged on a same side of the base substrate as the gate line groups, and an orthographic projection, on the base substrate, of at least one of the plurality of common wires is located between orthographic projections, on the base substrate, of adjacent gate line groups;
a plurality of connection lines, wherein the plurality of connection lines are arranged on the same side of the base substrate as the gate line groups, and an orthographic projection, on the base substrate, of at least one of the plurality of connection lines is located in an orthographic projection, on the base substrate, of a gap between adjacent pixel electrode rows; and
an insulation layer, wherein the insulation layer is arranged between the connection lines and the common wires and provided with a plurality of first via holes, and the common wires are connected with the connection lines at the first via holes to electrically connect at least part of the common wires through the connection lines; and orthographic projections, on the base substrate, of the first via holes are located in orthographic projections, on the base substrate, of regions between two pixel edge extension lines, extending in the second direction, of the pixel electrodes.

2. The array substrate according to claim 1, wherein the pixel electrodes have first symmetry axes extending in the second direction and penetrating central regions of the pixel electrodes, and the first symmetry axes penetrate central regions of the first via holes.

3. The array substrate according to claim 1, wherein the orthographic projections, on the base substrate, of the first via holes are located in the orthographic projections, on the base substrate, of gaps between adjacent pixel electrode rows.

4. The array substrate according to claim 1, wherein the first via holes comprise: first via sub-holes and second via sub-holes; each of the connection lines comprises: first connection sub-lines and second connection sub-lines that extend in the first direction;
the first connection sub-line is electrically connected with common wires on a side of the gate line group through the first via sub-hole; and
the second connection sub-line is electrically connected with the common wire on the other side of the gate line group through the second via sub-hole.

5. The array substrate according to claim 4, wherein the first connection sub-line is provided with a first protrusion protruding towards one side of the pixel electrode, and the common wire is provided with a second protrusion protruding towards one side of the gate line group; an orthographic projection, on the base substrate, of the first protrusion has a first overlapping region with an orthographic projection, on the base substrate, of the second protrusion; and the first protrusion is connected with the second protrusion through the first via sub-hole in the first overlapping region;
the second connection sub-line is provided with a third protrusion protruding towards one side of the pixel electrode, and the common wire is provided with a fourth protrusion protruding towards one side of the gate line group; and an orthographic projection, on the base substrate, of the third protrusion has a second overlapping region with an orthographic projection, on the base substrate, of the fourth protrusion; and the third protrusion is connected with the fourth protrusion through the second via sub-hole in the second overlapping region.

6. The array substrate according to claim 5, wherein the pixel electrode is provided with a first recess at a position opposite the first protrusion; and a gap is provided between an orthographic projection, on the base substrate, of the first recess and the orthographic projection, on the base substrate, of the first protrusion; the gate line is provided with a second recess at a position opposite the second protrusion, and a gap is provided between an orthographic projection, on the base substrate, of the second recess and the orthographic projection, on the base substrate, of the second protrusion;
the pixel electrode is provided with a third recess at a position opposite the third protrusion, and a gap is provided between an orthographic projection, on the base substrate, of the third recess and the orthographic projection, on the base substrate, of the third protrusion; and the gate line is provided with a fourth recess at a position opposite the fourth protrusion, and a gap is provided between a orthographic projection, on the base substrate, of the fourth recess and the orthographic projection, on the base substrate, of the fourth protrusion.

7. The array substrate according to claim 4, wherein the connection line comprise: a plurality of connection rings sequentially distributed in the first direction, and serial connection portions connecting adjacent connection rings; and the connection ring comprises the first connection sub-line and the second connection sub-line.

8. The array substrate according to claim 7, wherein the first via sub-hole and the second via sub-hole are respectively located in different connection rings; or
the first via sub-hole and the second via sub-hole are located in a same connection ring.

9. (canceled)

10. The array substrate according to claim 7, wherein the first pixel electrode is provided with a first outer edge on a side far away from the second pixel electrode and extending in the second direction, and the second pixel electrode is provided with a second outer edge on a side far away from the first pixel electrode and extending in the second direction; and
an orthographic projection, on the base substrate, of the connection ring is located in an orthographic projection, on the base substrate, of a region between an extension line of the first outer edge and an extension line of the second outer edge.

11. The array substrate according to claim 7, wherein a length of the connection ring in the first direction is 1 time to 2 times a length of the pixel electrode in the first direction;
a minimum line width of the first connection sub-line is smaller than a maximum width of the gate line in the second direction; a minimum line width of the second connection sub-line is smaller than the maximum width of the gate line in the second direction; and a line width of the serial connection portion is smaller than the maximum width of the gate line in the second direction.

12. The array substrate according to claim 7, wherein an orthographic projection, on the base substrate, of an outer edge of the connection ring in the first direction partially overlaps with an orthographic projection, on the base substrate, of an outer edge of the gate line towards the pixel electrode.

13. (canceled)

14. The array substrate according to claim 1, wherein at least one of the plurality of transistors comprises: a gate electrode electrically connected with the gate line, a first electrode electrically connected with the data line, and a second electrode electrically connected with the pixel electrode; and
a second electrode, connected with the first pixel electrode, of one transistor and a second electrode, connected with the second pixel electrode, of another transistor are symmetrical with respect to the data line.

15. The array substrate according to claim 14, wherein the second electrode comprises:
a first portion and a second portion extending in the second direction, wherein an extension line of the first portion and an extension line of the second portion do not overlap with each other; and
a third portion that extends in the first direction and connects the first portion and the second portion;
wherein a length of a third portion, connected with the first pixel electrode, of the one transistor is substantially equal to a length of a third portion, connected with the second pixel electrode, of the another transistor.

16. The array substrate according to claim 15, wherein an orthographic projection, on the base substrate, of the extension line of a first portion of the one transistor connected with the first pixel electrode is located in an orthographic projection, on the base substrate, of a gap between adjacent pixel electrodes; or
an orthographic projection, on the base substrate, of the second portion has an overlapping region with an orthographic projection, on the base substrate, of the pixel electrode.

17. (canceled)

18. The array substrate according to claim 14, wherein the second electrode comprises: a fourth portion extending in the second direction, and a fifth portion extending in the first direction and connected with one end of the fourth portion; and
an orthographic projection, on the base substrate, of the fourth portion has an overlapping region with an orthographic projection, on the base substrate, of a gap between adjacent pixel electrodes.

19. The array substrate according to claim 1, comprising: first common signal lines between adjacent gate line groups and extending in the first direction, and first common signal extension lines connected with one sides of the first common signal lines and extending in the second direction; and
at least some of the first common signal extension lines serve as the common wires.

20. The array substrate according to claim 1, comprising: second common signal line groups between adjacent gate line groups and extending in the second direction, wherein each of the second common signal line groups comprises two second common signal lines located on different sides of the data line respectively; each of the second common signal lines comprises: a primary portion of the second common signal line extending in the second direction, and a branch portion of the second common signal line extending from one end of the primary portion of the second common signal line in the first direction; and
at least some of the second common signal lines serve as the common wires, and the second common signal line is electrically connected with the connection line through the branch portion of the second common signal line.

21. The array substrate according to claim 1, comprising: a third common signal line between adjacent gate line groups and extending in the second direction, and an orthographic projection of the third common signal line on the base substrate, is located between an orthographic projection of the first pixel electrode on the base substrate and an orthographic projection of the second pixel electrode on the base substrate.

22. (canceled)

23. A display panel, comprising the array substrate according to claim 1, and further comprising an opposite substrate arranged opposite to the array substrate, wherein a common electrode layer is arranged on a side of the opposite substrate facing the array substrate.

24. A display device, comprising the display panel according to claim 23.
